(19) United States
(12) Patent Application Publication
(10) Pub. No.: US 2022/0405690 A1
(43) Pub. Date: Dec. 22, 2022

(54) INFORMATION PROCESSING APPARATUS, INFORMATION PROCESSING METHOD, AND STORAGE MEDIUM

(71) Applicant: HONDA MOTOR CO., LTD., Tokyo (JP)

(72) Inventors: Megumi HIRAKAWA, Tokyo (JP); Satoshi MURATA, Tokyo (JP); Sota SAKAGUCHI, Tokyo (JP); Shohei NAMIKI, Tokyo (JP); Ryota HISADA, Tokyo (JP); Ryuichi KIMATA, Tokyo (JP)

(21) Appl. No.: 17/832,950

(22) Filed: Jun. 6, 2022

(30) Foreign Application Priority Data
Jun. 18, 2021 (JP) 2021-101779

(51) Int. Cl. G06Q 10/06; A01D 34/00; G05D 1/00

(52) U.S. Cl. CPC G06Q 10/063114; G06Q 10/06316; A01D 34/008; G05D 1/0044; A01D 2101/00

(57) ABSTRACT

There is provided with an information processing apparatus. A storing unit stores a work plan indicating a work schedule by an autonomous work machine, the work plan using divided areas obtained by virtually dividing a work area. An identifying unit identifies the divided areas where the work by the autonomous work machine has been completed. A notifying unit gives a worker a notification for prompting the worker to conduct work in the divided area where the work by the autonomous work machine has been completed.

### CROSS-REFERENCE TO RELATED APPLICATION(S)

This application claims priority to and the benefit of Japanese Patent Application No. 2021-101779 filed on Jun. 18, 2021, the entire disclosure of which is incorporated herein by reference.

### BACKGROUND OF THE INVENTION

### Field of the Invention

The present invention relates to an information processing apparatus, an information processing method, and a storage medium.

### Description of the Related Art

In parks, gardens, and the like, work such as lawn cutting and grass cutting is conducted by a landscape contractor (landscaper), in some cases. The landscape contractor conducts the work by a worker (for example, by use of a handheld work machine or manually), and in addition, uses a large-sized autonomous work machine for the work that does not need human labor, in some cases. Japanese Patent Laid-Open No. 2009-118823 discloses a lawn mower that can be used by a worker.

In a case where the autonomous work machine and the worker conduct the work in parallel, it is not easy to ascertain an area where it is possible for the worker to conduct the work in relation to the autonomous work machine that is conducting the work.

### SUMMARY OF THE INVENTION

An object of the present invention is to facilitate ascertaining of an area where it is possible for a worker to conduct the work during the use of an autonomous work machine.

According to one embodiment of the present disclosure, an information processing apparatus comprises: a storing unit configured to store a work plan indicating a work schedule by an autonomous work machine, the work plan using divided areas obtained by virtually dividing a work area; an identifying unit configured to identify the divided areas where the work by the autonomous work machine has been completed; and a notifying unit configured to give a worker a notification for prompting the worker to conduct work in the divided area where the work by the autonomous work machine has been completed.

According to another embodiment of the present disclosure, an information processing method executed by an information processing apparatus comprising a storing unit configured to store a work plan indicating a work schedule by an autonomous work machine, the work plan using divided areas obtained by virtually dividing a work area, comprises: identifying the divided areas where the work by the autonomous work machine has been completed; and giving a worker a notification for prompting the worker to conduct work in the divided area where the work by the autonomous work machine has been completed.

According to still another embodiment of the present disclosure, a non-transitory computer-readable storage medium storing a program that, when executed by a computer, causes the computer to perform an information processing method executed by an information processing apparatus comprising a storing unit configured to store a work plan indicating a work schedule by an autonomous work machine, the work plan using divided areas obtained by virtually dividing a work area, comprises: identifying the divided areas where the work by the autonomous work machine has been completed; and giving a worker a notification for prompting the worker to conduct work in the divided area where the work by the autonomous work machine has been completed.

### BRIEF DESCRIPTION OF THE DRAWINGS

FIG. 1 is a diagram illustrating an example of a system according to the present embodiment;

FIG. 2 is a diagram illustrating an example of a functional configuration of an information processing apparatus according to the present embodiment;

FIG. 3 is a diagram illustrating an example of a work map according to the present embodiment;

FIG. 4 is a diagram illustrating another example of the work map according to the present embodiment;

FIG. 5 is a flowchart illustrating an example of an information process according to the present embodiment; and

FIG. 6 is a diagram illustrating an example of a GUI for generating divided areas according to the present embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

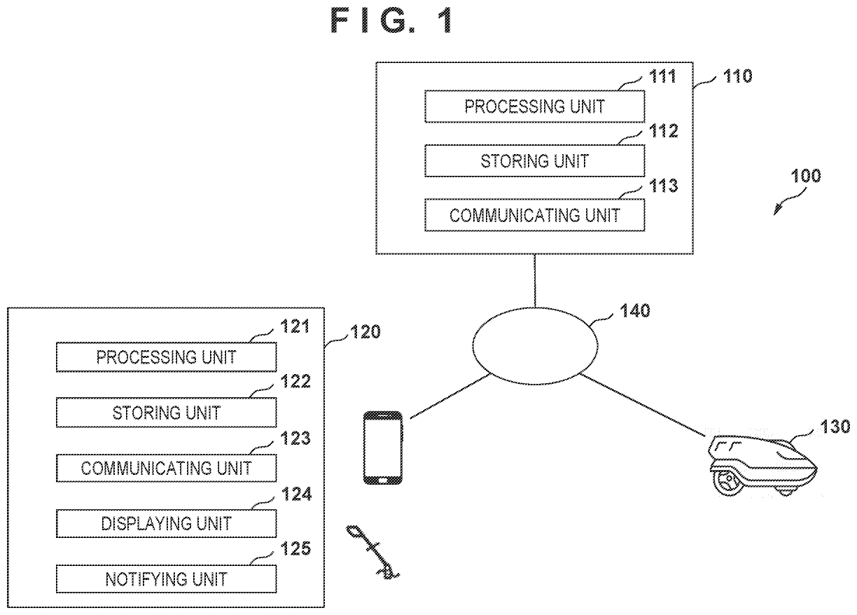

FIG. 1 is a diagram illustrating an example of a system 100 including an information processing apparatus 110 according to the present embodiment. The system 100 is a system that divides an area (work area) where work such as lawn cutting or grass cutting is conducted into divided areas and that presents, to a worker having a mobile terminal 120, the divided areas where the work by an autonomous work machine 130 has been completed as areas where it is possible for the worker to conduct the work. The information processing apparatus 110 is communicably connected with the terminal device 120 and the autonomous work machine 130 through a network. A network 140 is a network to be used when the information processing apparatus 110 communicates with the terminal device 120 and the autonomous work machine 130. Note that hereinafter, the work such as lawn cutting or grass cutting conducted by a landscaper will be collectively and simply referred to as grass cutting work. In the grass cutting work according to the present embodiment, the grass cutting in an area of lawn, or hedges, or the like is divided into autonomous work by the autonomous work machine 130 and work conducted by the worker. That is, after the work by the autonomous work machine 130, work by a worker using work equipment is conducted, such as grass cutting work in an area where it is difficult for a large-sized autonomous work machine to conduct the work near an obstacle such as a building, a tree, or a pond, or shaping work of the hedges using a trimmer.

The information processing apparatus 110 is, for example, a server, and stores information indicating divided areas obtained by virtually dividing a work area and a work plan indicating a work schedule by the autonomous work machine 130 and using the divided areas. In addition, the information processing apparatus 110 acquires information indicating an area where the work by the autonomous work machine 130 has been completed among the divided areas, and transmits, to the terminal device 120, a notification for prompting the worker to conduct the work for the area where the work has been completed.

The information processing apparatus 110 includes a processing unit 111, a storing unit 112, and a communicating unit 113. These functional units are connected by a bus, not illustrated. The processing unit 111 is, for example, a CPU, and is a processor that executes a program stored in the storing unit 112 to perform each process of the information processing apparatus 110 according to the present embodiment. The storing unit 112 is, for example, a storage device such as a ROM, a RAM, an HDD, or an SSD, and stores a program executed by the processing unit 111 and various types of data. The communicating unit 113 is a communication interface for communication with an external device.

The terminal device 120 is a terminal carried by the worker (user) who conducts the work. The terminal device 120 may be, for example, a portable device such as a smartphone or a PC carried by the worker, or may be an work equipment for the worker to conduct the work. In the following, the terminal device 120 will be described as a smartphone carried by the worker. However, for example, the smartphone and the work equipment may function in cooperation with each other as the terminal device 120. In the present embodiment, the smartphone and the work equipment are capable of connecting with each other on wireless communication, for example, Bluetooth communication or the like to transmit and receive position information. Here, the work conducted by the worker is the grass cutting work to be conducted by the landscaper. However, it is assumed that the work conducted by the autonomous work machine 130 is excluded. The work equipment will be described later.

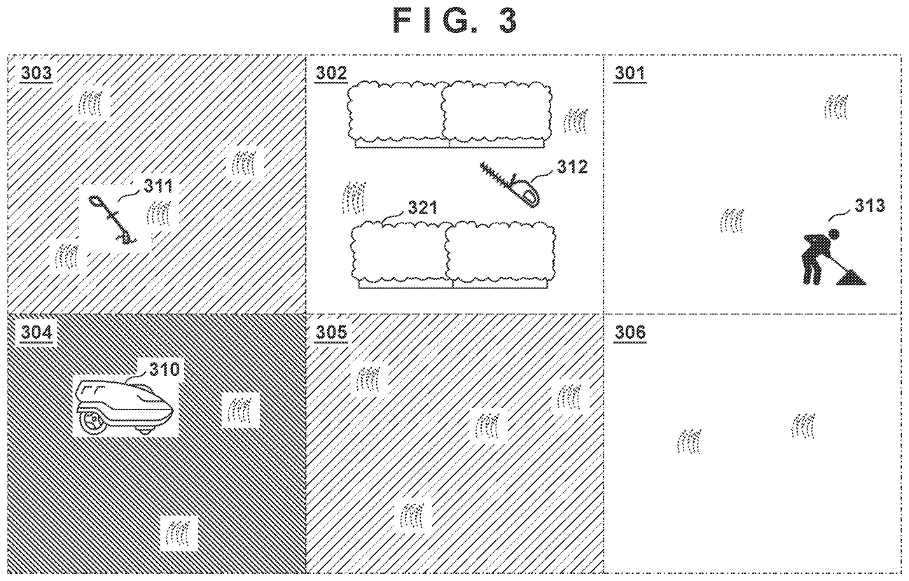

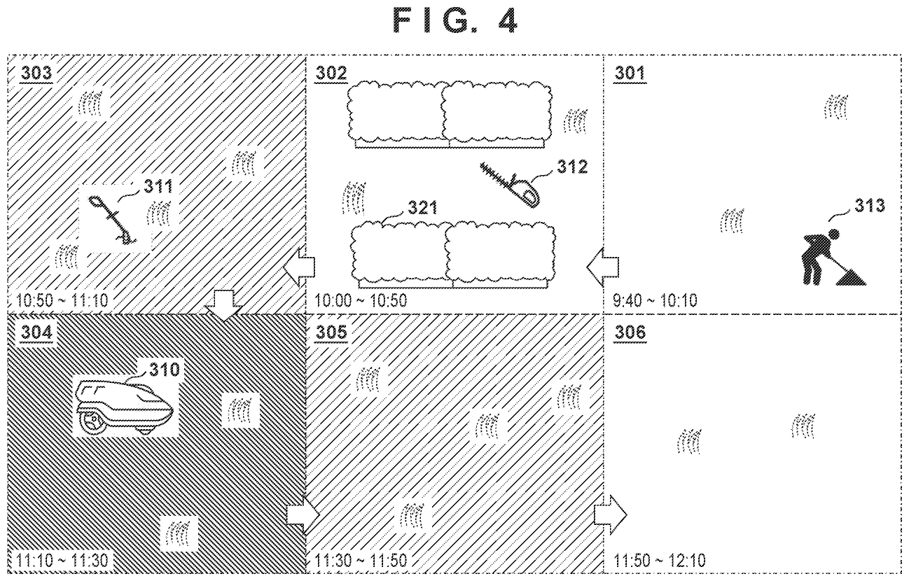

The terminal device 120 includes a processing unit 121, a storing unit 122, a communicating unit 123, a displaying unit 124, and a notifying unit 125. These functional units are connected by a bus, not illustrated. The processing unit 121 is, for example, a CPU, and is a processor that executes a program stored in the storing unit 122 to perform each process of the terminal device 120. The storing unit 122 is, for example, a storage device such as a ROM, a RAM, an HDD, or an SSD, and stores a program executed by the processing unit 121 and various types of data. The communicating unit 123 is a communication interface for communication with an external device. The displaying unit 124 is a display interface for displaying information that has been received from the information processing apparatus 110, and displays a work map that is color coded in the divided areas in accordance with contents of the work plan, as illustrated in, for example, FIG. 3 or FIG. 4 to be described later. In the present embodiment, the terminal device 120 is a smartphone, and the displaying unit 124 is a screen of the smartphone (for example, a liquid crystal display or an organic EL). However, its form is not particularly limited, as long as information can be presented to the worker. The displaying unit 124 may be, for example, a display mounted on the work equipment, or may be a display of a PC or an external device. The terminal device 120 may be implemented as a plurality of individual devices as various work equipment.

The storing unit 122 stores information of the divided areas obtained by virtually dividing the work area where the grass cutting work is to be conducted by the landscaper. In addition, the storing unit 122 stores a work plan indicating a work schedule by the autonomous work machine 130 and using the divided areas. Although the divided areas and the work plan will be described in detail later, the autonomous work machine 130 according to the present embodiment conducts the grass cutting work for every divided area.

The notifying unit 125 notifies the worker of the divided area where the autonomous work machine 130 has completed the work. For this purpose, the information processing apparatus 110 identifies the divided area where the autonomous work machine 130 has completed the work, and transmits its information to the terminal device 120. The notifying unit 125 according to the present embodiment receives a notification that it is possible for the worker to conduct the work in the divided area that has been identified from the information processing apparatus 110, and gives a notification to the worker. Hereinafter, a description will be given assuming that the notification given by the notifying unit 125 is indicated by the work map displayed (color coded) on the displaying unit 124. However, it is not particularly limited, as long as it is possible to give a notification to the worker, such as giving the notification by outputting synthetic sound or recorded sound with use of a speaker, not illustrated.

The autonomous work machine 130 is a robot mower that autonomously conducts the grass cutting work. The autonomous work machine 130 according to the present embodiment conducts grass cutting in an area of lawn, or hedges, or the like in accordance with a work plan. The autonomous work machine 130 autonomously conducts the grass cutting work without depending on the manual operation. However, the autonomous work machine may be configured to be operable by a person in consideration of the operation by a supervisor who supervises the work (that is, for example, may have a configuration as a riding mower, a walking mower, or the like).

The work equipment according to the present embodiment is equipment used by a worker at the time of grass cutting work, for example, an edger, a trimmer, a cutting machine, or a blower, or the like. Here, a description will be given assuming that these types of work equipment are riding devices to be activated with electric power, such as edgers or blowers, or manually-operated handheld devices. However, these types of work equipment may be any of typical equipment used for cutting grass, such as rakes (forks).

In the present embodiment, divided areas obtained by virtually dividing a work area are set, and a work plan indicating a work schedule in the divided areas by the autonomous work machine is stored in the storing unit 112. When the autonomous work machine 130 completes the work in a certain divided area, the information processing apparatus 110 presents, to the terminal device 120, information indicating the divided area where the work has been completed, and gives a notification for prompting the worker to conduct the work. Through such a process, in a case where the work by the autonomous work machine and the work by the worker are conducted in parallel, it is possible to present, to the worker, the place where it is possible for the worker to conduct the work. Therefore, the efficiency of the grass cutting work can be improved. Here, whenever the work in every divided area is completed, the autonomous work machine 130 is capable of notifying the terminal device 120 that it is going to shift to the work in the next divided area.

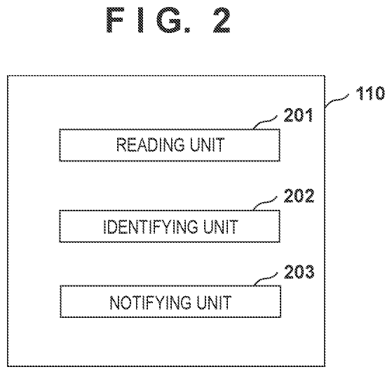

Hereinafter, a description will be given with regard to a process performed on the system 100 by the information processing apparatus 110 according to the present embodiment with reference to FIGS. 2 and 3.

FIG. 2 is a block diagram illustrating an example of a functional configuration included in the information processing apparatus 110 according to the present embodiment. The information processing apparatus 110 includes a reading unit 201, an identifying unit 202, and a notifying unit 203.

The reading unit 201 acquires, from the storing unit 122, information of the work area and information of the divided areas obtained by virtually dividing the work area. Here, a description will be given assuming that data of the work area such as a bird's-eye view is created beforehand, and the divided areas have also been already created. The work area divided into the divided areas is displayed as the work map illustrated in FIG. 3, for example. Next, the reading unit 201 acquires, from the storing unit 122, the work plan indicating a schedule of the work by the autonomous work machine on the work map. The work plan will be described later with reference to FIG. 3.

The identifying unit 202 identifies the divided area where the work by the autonomous work machine 130 has been completed, on the work map. Here, when the autonomous work machine 130 completes the work in one divided area, the identifying unit 202 is capable of receiving information indicating that the divided area is an area where the work has been completed, from the autonomous work machine 130. In addition, the identifying unit 202 may identify position information of the autonomous work machine 130 using, for example, a sensor or the like or through communication, and may confirm a completion situation of the work by the autonomous work machine 130, based on the position information that has been identified. In such a case, for example, when detecting that the autonomous work machine 130 has moved from the divided area where it is conducting the work to the next divided area (the autonomous work machine 130 is positioned in the next divided area), the identifying unit 202 may consider that the work in the divided area has been completed before the movement.

The notifying unit 203 causes the notifying unit 125 to give a notification about the divided area where the work by the autonomous work machine has been completed so as to prompt the worker to conduct the work. Here, in order to display the divided areas for prompting the worker to conduct the work, the notifying unit 203 updates the work map so as to display in a different form for every divided area, and causes the terminal device 120 to display the work map. Furthermore, the notifying unit 203 may give a notification to the worker, for example, by giving a push notification on the smartphone, which is the terminal device 120. The display on the work map will be described later with reference to FIG. 3.

Note that the identifying unit 202 may identify the divided area where the work by the worker having the terminal device 120 has been completed in the same manner as identifying the divided area where the work by the autonomous work machine 130 has been completed. For example, a consideration is given to a case where the work by the autonomous work machine 130, and subsequently, edger work is conducted and then blower work is conducted. When the work by the autonomous work machine 130 is completed in a certain divided area, the notifying unit 203 notifies the terminal device 120 that it is possible to conduct the edger work in such an area, and prompts conducting of the edger work. Next, when the worker completes the edger work, the notifying unit 203 notifies the terminal device 120 that it is possible to conduct the blower work in such an area, and prompts a notification for the blower work. In this manner, by giving a notification in a different display whenever the work is completed, it becomes possible to give a notification about at which timing the work should be conducted in each divided area in an easy-to-understand manner.

In the following, a description will be given assuming that when the autonomous work machine 130 moves from the divided area where it is conducting the work to the next divided area, it is determined that the work in such a work area has been completed. However, the condition for determining that the work has been completed is not particularly limited to this. For example, when a work situation by the autonomous work machine 130 in a certain divided area satisfies a predetermined condition, the identifying unit 202 may determine that the work in such a divided area is to be completed, and may cause the notifying unit 203 to give a notification about information indicating the completion. Here, the case where the work situation satisfies the predetermined condition denotes a case where a progressing degree of the work exceeds a predetermined degree, and for example, may be a case where the autonomous work machine 130 completes the work in a range equal to or larger than a predetermined ratio of the divided area, or may be a case where a remaining work amount (required time calculated from its surface area or the work plan) of the divided area is equal to or smaller than a predetermined threshold. In addition, the identifying unit 202 may determine that the work in the divided area has been completed at a predetermined timing after the work in the divided area is to be completed so that it is possible to prompt the worker to conduct the work after the safety is ensured with more certainty. The condition set as the predetermined timing here is not particularly limited, as long as it is a condition that can be set as a safety margin. Such a predetermined timing may be, for example, when a fixed time has elapsed since the information indicating that the work in the above-described divided area is to be completed is received, or may be when the remaining required time in the divided area calculated from the work plan has elapsed. According to such a process, the notification is given before the autonomous work machine 130 moves to the next divided area, so that the notification can be given at a timing without a time loss in consideration of the time until the worker who has received the notification moves to the divided area. Note that when the autonomous work machine 130 moves to the next divided area, in a case where it is determined that the work has been completed in the area where the autonomous work machine 130 was conducting the work, the worker is prompted to enter the divided area where the autonomous work machine 130 is not present with certainty, and the safety of the worker can be further ensured.

[Work Map]

FIG. 3 is a diagram illustrating an example of the work map to be displayed on the terminal device 120 by the notifying unit 203 and indicating each divided area, while the landscaper is conducting the grass cutting work. Here, the work map is divided into six divided areas of areas 301 to 306, and an autonomous work machine 310 conducts the work in each divided area in a sequential order scheduled in the work plan. The autonomous work machine 310 in FIG. 3 has just completed the work in the area 303 and moved to the area 304. On a work map 300, in addition to the autonomous work machine 310, icons of an edger 311 and a trimmer 312 who is conducting the work, and a worker 313 who is manually conducting the work are individually displayed on the divided areas. In the area 303 where the work by the autonomous work machine 310 has been completed, the edger work by the edger 311 is being conducted. In addition, in the area 302 where hedges exist and the work by the autonomous work machine 310 has been completed, the trimmer work by the trimmer 312 is being conducted. Furthermore, in the area 301 where the work by the autonomous work machine 310 has been completed and the grass cutting work by a handheld device such as the edger 311 has also been completed, the grass is being manually collected by the worker 313. In the work map displayed in FIG. 3, it is assumed that the area 304 where the work by the autonomous work machine 310 is being conducted is displayed and colored in red, and the areas 301 to 303 where the work by the autonomous work machine 310 has been completed are displayed and colored in blue.

In this example, the work plan including a moving route of the autonomous work machine 310 has been created beforehand so that the work is conducted sequentially in the areas 301 to 306. In a case where hedges exist in a work area (or its vicinity), a work plan may be created such that the work in the divided area where the hedges exist should be conducted on a priority basis, so that the work can be shifted to the trimmer work for the hedges at an early stage. In addition, in a case where an obstacle exist in a work area (or its vicinity), a work plan may be created such that the work in the divided area where the obstacle exist should be conducted on a priority basis, so that the work can be shifted to the edger work around the obstacle at an early stage. Other than that, the work plan may be created so as to have a sequential order as the user desires in accordance with the contents of the work, such as a divided area where the total work time increases, or a divided area where the work is desirably conducted earlier, or the like. In the work plan in the example of FIG. 3, a work start point is the area 301 and hedges 321 exist in the area 302. Hence, the autonomous work machine 310 advances from the area 301 to the area 302, but the work start point may be set to the area 302. Here, it is assumed that the moving route of the autonomous work machine 310 included in the work plan is set by the landscaper before the grass cutting work, but may be generated before the work with use of, for example, machine learning or the like, based on the contents of the work map. For example, in a case where there are a plurality of divided areas where the hedges or the obstacles exist, the priorities may be calculated in accordance with the surface areas of the hedges or the obstacles in the divided areas, and the moving route of the autonomous work machine 310 may be determined in accordance with the priorities that have been calculated.

Hereinafter, in this work map, a different display depending on the progress in each of the work by the autonomous work machine 310 and the work by the worker is provided for each divided area so that the work situation can be more easily ascertained. In this example, it is assumed that every divided area is displayed in a color depending on the work situation. However, for example, the divided area where the work by the autonomous work machine 310 is being conducted is displayed in a blinking manner, the divided area where it is possible for the worker to conduct the work is displayed in an emphasized manner, or any display for visually distinguishing those areas from the other areas is available. The areas with different work situations are displayed in different modes, and thus what work should be conducted in the areas can be easily understood in a visual manner. In addition, for example, for every divided area, an icon or characters corresponding to the work that is currently conducted (for example, an icon of the edger or characters of “edger” are displayed on the divided area where the work by the edger is conducted) may be displayed to give a notification about the work in the area. Regarding the position where the icon or the like is displayed, position information of the terminal device 120 may be acquired to be reflected on the work map, or the icon or the like may be displayed at a fixed position. Regarding the divided area where the work by the worker has also been completely completed, the display may be provided from which it is easy to ascertain visually the fact that the work no longer has to be conducted, for example, by displaying in a dark color, painting, or deleting from the work map.

The information processing apparatus 110 identifies an area where the work by the autonomous work machine has been completed, and prompts the worker to conduct the work in the identified area. In the example of FIG. 3, the divided area where the work by the autonomous work machine 310 has been completed and the other divided areas are displayed in different colors (the area where the work has been completed is displayed in blue). Thus, the area where the work by the autonomous work machine 310 has been completed is identified. Here, the notifying unit 203 is capable of notifying the user in any method by, for example, highlighting only the area where the work by the autonomous work machine has been completed.

Further, the notifying unit 203 is capable of displaying in different forms so that the work to be conducted next can be understood on the work map in accordance with a progress situation of each of the work conducted by the worker 313 subsequent to the work by the autonomous work machine 310. That is, whenever each work is completed in a divided area, the notifying unit 203 is capable of changing the display color of such a divided area, and presenting information indicating the work scheduled to be conducted next to the user. In this example, in each area, the work is conducted in a sequential order of the work by the autonomous work machine 310, the work by the edger, (the work by the trimmer), the work by the blower, and then the grass collecting work by the worker. Therefore, the different colors may be displayed, based on the progress situations of these types of work. Note that the content of the work or the sequential order of the work to be conducted for every divided area may differ depending on the position of the divided area, or the presence or absence of an obstacle in the divided area, or the like.

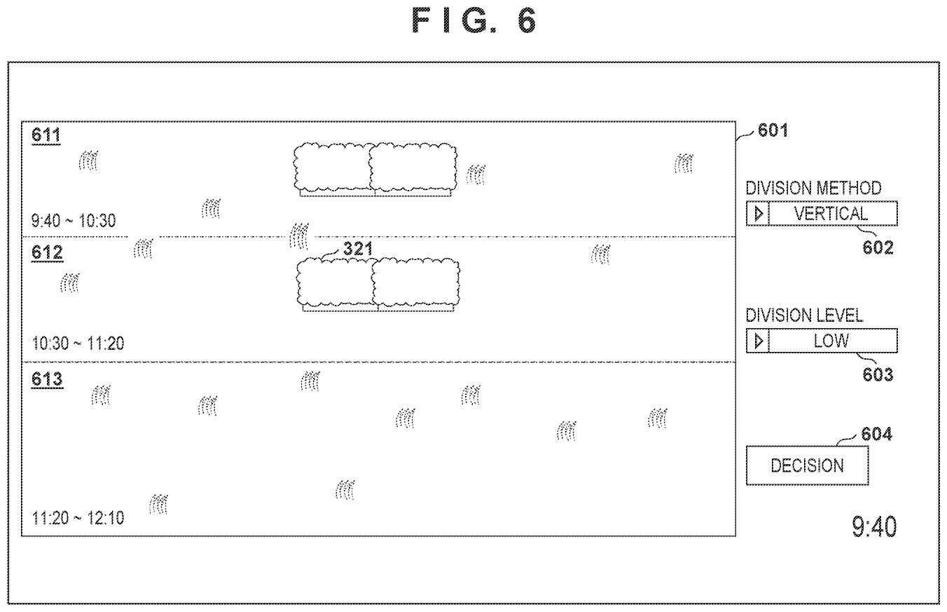

Furthermore, the notifying unit 203 may display, on the work map, additional information that can be acquired from the work plan. FIG. 4 is a diagram illustrating an example of a work map 400 that displays information different from the example of FIG. 3. The work map 400 is a map for displaying the divided areas 301 to 306, which are similarly divided in the work area same with the work map 300. In the example of FIG. 4, the notifying unit 203 displays, on the work map 400, a sequential order in which the work by the autonomous work machine 310 is conducted. Although this order is displayed by arrows in the example of FIG. 4, for example, a symbol or a number indicating the sequential order of the work may be displayed for every divided area. In addition, in the example of FIG. 4, each predicted work time to be conducted by the autonomous work machine 310 in each divided area is set, and the work times are displayed on the work map. In this example, the autonomous work machine 310 conducts the work in the area 401 from 9:40 to 10:00, in the area 402 from 10:00 to 10:50, in the area 403 from 10:50 to 11:10, and starts the work in the area 404 from 11:10. The predicted work time may be displayed in each divided area, or the divided area and the work time may be displayed in association with each other in an area outside the work area of the work map displayed on the displaying unit 124. The work time is not particularly limited to this, as long as the work time is displayed in a form that the worker can recognize. In addition, in the example of FIG. 4, the work time by the autonomous work machine 310 is consistently displayed. However, the work time displayed here is not particularly limited to this, as long as it is the scheduled time of the work in the area. For example, the notifying unit 203 may display the period of the work as illustrated in FIG. 4 as the work time, may display a start time of the work, or may display an end time of the work. In addition, after the work by the autonomous work machine 310 has been completed, the notifying unit 203 may display the scheduled work time of the subsequent work, or the scheduled time until the start of the next work, or the like. These work times are set, based on of the current time at the start of the work via a GUI as illustrated in FIG. 6 to be described later, for example.

Further, in the example of FIG. 4, the notifying unit 203 displays in different forms between the divided areas in the vicinity of the autonomous work machine that is conducting the work and the other divided areas. To be specific, the divided area where the autonomous work machine is conducting the work is displayed in red, the divided areas adjacent to the divided area where the autonomous work machine is conducting the work are displayed in yellow, and the other divided areas are displayed in blue. According to such a process, different displays are provided in the vicinity of the area where the large-sized autonomous work machine is conducting the work, and the user confirms the displays, so that the user can conduct the work more safely while avoiding the vicinity of the autonomous work machine. Here, it is assumed that the adjacent divided areas are present on the work map among the four areas on the upper, lower, left, and right sides of the divided area. However, for example, the adjacent divided areas may be present on the work map among eight surrounding areas, or may be individually defined in accordance with a shape of the divided area or a desired condition. Further, in this example, regarding the areas 301 to 303 where the work by the autonomous work machine 310 has been completed, the area or a frame line of the area is displayed in a flashing manner. Thus, it is possible to give a notification for prompting the worker to conduct the work.

Note that, for example, it is conceivable that there is a case where the progress of work is delayed with respect to the work plan, such as a case where there are lots of obstacles in the divided area. From such a viewpoint, when identifying the divided area where the work by the autonomous work machine 130 has been completed, the identifying unit 202 may simultaneously acquire the time when the work was completed. In a case where the time is deviated as compared with the work plan, the scheduled time of the subsequent work in the work plan may be corrected, based on the deviation. For example, when the work is delayed by 10 minutes from the original schedule, the entire work time in the work plan is delayed by 10 minutes, and the deviation is also reflected on the display on the work map.

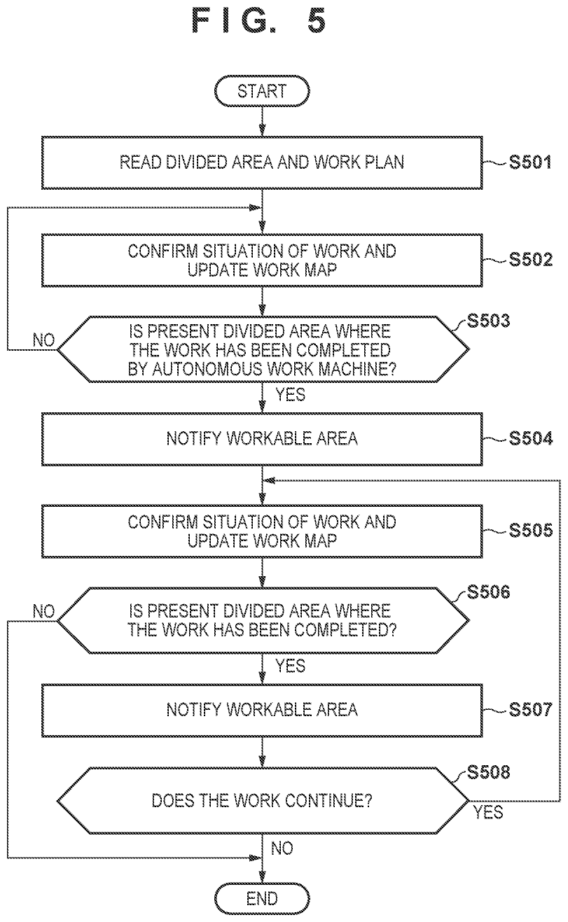

FIG. 5 is a flowchart illustrating an example of a notification process performed by the information processing apparatus 110 to notify the terminal device 120 according to the present embodiment. It is assumed that the process illustrated in FIG. 5 is started in accordance with a start instruction for the grass cutting work by the landscaper.

In step S501, the reading unit 201 reads, from the storing unit 112, the information of the work area, the information of the divided areas obtained by virtually dividing the work area, and the work plan using the divided areas.

In step S502, the identifying unit 202 communicates with the autonomous work machine 130, confirms the completion situation of the work by the autonomous work machine 130, identifies the area where the work has been completed, and updates the work map. Here, when the autonomous work machine 130 completes the work in one divided area, it is assumed that the divided area is an area where the work has been completed, and information is transmitted to the information processing apparatus 110. The identifying unit 202 confirms whether there is a divided area where the work by the autonomous work machine 130 has been completed, based on the information that has been received from the autonomous work machine. In displaying the work time on the work map, the identifying unit 202 reads the current time, and when a delay is occurring, such a delay is reflected on the work map.

In step S503, the identifying unit 202 determines whether the divided area where the work by the autonomous work machine 130 has been completed is present in the work map, based on the information confirmed in step S502. In a case where the divided area is present, the process proceeds to step S504, and in the other case, the process returns to step S502.

In step S504, the notifying unit 203 causes the terminal device 120 to display and notify that it is possible for the worker to conduct the work in the divided area where the work by the autonomous work machine 130 has been completed. The work map is displayed on the terminal device 120 as described above. However, in this process, it is sufficient if only the divided area where the work by the autonomous work machine 130 has been completed is displayed.

In step S505, the identifying unit 202 communicates with the autonomous work machine 130, confirms the completion situation of the work by the autonomous work machine 130, and updates the work map. This process is performed in the same manner as the process in step S502. However, in addition to that, the identifying unit 202 may also confirm the completion status of the work by the handheld device (worker).

In step S506, the notifying unit 203 determines whether there is a divided area where the work by the autonomous work machine 130 or the work by the worker has been newly completed in the work map, based on the information confirmed in step S505. In a case where such a divided area is present, the process proceeds to step S507, and in the other case, the process ends.

In step S507, the notifying unit 203 causes the terminal device 120 to display and notify that it is possible for the worker to conduct the subsequent work in the divided area where the work by the autonomous work machine 130 or the work by the worker has been newly completed. Note that in a case where there is no subsequent work (when the work in the divided area is completed), an instruction is given to the terminal device 120 to display that the work has been completed. In step S508, the notifying unit 203 determines whether to still continue the grass cutting work. In a case of continuing the grass cutting work, the process returns to step S505, and in a case of not continuing the grass cutting work, the process ends.

According to such a process, after the work plan in the divided area is read and the area where the autonomous work machine has completed the work is identified, it is possible to give a notification for prompting the worker to conduct the work in the work completed area that has been identified. Therefore, in a case where the work by the autonomous work machine and the work by the worker are conducted in parallel, it becomes possible to easily ascertain the area where it is possible for the worker to conduct the work. In addition, the work that does not need human labor is automated by the autonomous work machine, so that unevenness in work contents can be reduced, and an error in estimation of work costs can be reduced.

Note that in the above example, the description has been given assuming that there is one autonomous work machine 130. However, a plurality of autonomous work machines 130 may conduct the work in the work area. In such a case, the autonomous work machines 130 may perform respectively different types of work, and there may be the autonomous work machines 130 conducting the identical work. Even in a case where there are a plurality of autonomous work machines 130, the identifying unit 202 identifies the divided area where necessary work has been completed on the work map, and a notification is transmitted to prompt the worker to conduct the work in the identified area. In addition, in the case where there are a plurality of autonomous work machines, each of the autonomous work machines are connected on wireless communication for cooperation, and is capable of giving an instruction to the terminal device 120. That is, for example, it is possible to conduct efficient control so that the identical notifications should not be transmitted to the terminal device 120 from the plurality of autonomous work machines.

The number of workers (terminal devices 120) in the work area is not particularly limited. In a case where there are a plurality of workers, the above-described notification may be transmitted to each of the workers, or the work corresponding to each terminal device carried by the worker may be registered, so that the notification may be selectively transmitted to the terminal device corresponding to the work to be conducted next in accordance with the work plan.

Further, in the present embodiment, an example in which the information processing apparatus 110 functions as a server has been described. However, this configuration is not particularly limited, as long as a similar function is provided. For example, the autonomous work machine 130 may be communicably connected with the terminal device 120 on wireless communication such as Bluetooth (registered trademark) to function as the entirety or a part of the information processing apparatus 110. In such a case, the autonomous work machine 130 is capable of transmitting and receiving position information to and from the terminal device 120. When completing the work in a certain divided area, the autonomous work machine transmits the fact to the terminal device 120 on wireless communication, so that the notification for prompting the worker to conduct the work can be given. According to such a configuration, when the autonomous work machine 130 completes the work in the divided area, the autonomous work machine 130 is capable of directly transmitting, to the terminal device 120, the fact that it becomes possible for the worker to conduct the work in the divided area, and updating the display of the work map.

In addition, the method for dividing the work area is not particularly limited as illustrated in FIG. 3. For example, the size, shape, or the like of each divided area may not necessarily be unified, and in addition, any value may be set to the number of divided areas. In the present embodiment, it is assumed that a user makes settings with regard to the division to determine a division method and an estimation time of work for every divided area or a size of the divided area, and the divided areas are generated and stored in the storing unit 122. Further, the work area may be divided into the divided areas in accordance with a user's input, may be divided into a grid shape having a predetermined size, or may be divided by calculating estimations of work times in accordance with an obstacle or the like on the work area, so that the working time is almost even. Furthermore, for example, in a case where an area where the work by the autonomous work machine 130 is not conducted, for example, a road or a building or the like, is included in the work area, the work area may be divided not to include such an area in the divided area.

FIG. 6 is a diagram illustrating an example of a GUI on the terminal device 120 that receives a user's input in dividing the work map. In FIG. 6, a displaying unit 601 for displaying the work area illustrated in FIG. 3, a box 602 for setting a division method, and a box 603 for setting a division level are displayed. Here, regarding the items in the boxes 602 and 603, it is assumed that preset options are presented in a pull-down list and the user selects from them. Here, it is assumed that, for example, it is possible to select vertical, horizontal, or grid divisions as the division method in the box 602. In FIG. 6, the vertical division is selected, and the work area is divided into three divided areas of areas 611 to 613 by the boundaries in x-axis direction. In a case where the horizontal division is selected, the work area is divided by the boundaries in y-axis direction. In a case where the grid division is selected, the work area is divided in a grid shape as illustrated in FIG. 3.

As the division level in the box 603, for example, it is possible to select strong, medium, or low, so that the work time to be spent for every divided area is determined in accordance with the selection. Here, low is selected in the division level, and the work area is divided into three areas 611 to 613 so that each work time is 50 minutes. However, it is possible to set the degree of the division as the user desires, for example, when medium is selected in the division level, the work area is divided into four. Here, the work time is calculated in accordance with the size of the divided area and the type and size of hedges, or an obstacle, or the like in the divided area. In addition, the size of each area to be divided in accordance with the division level may be determined. Further, the boxes 602 and 603 are examples, and optional setting items such as a range of the work area, a change of the work area, or work content to be conducted for every work area, for example, may be separately provided. In this example, after these settings are made, a decision button 604 is pressed. Then, the divided areas that have been set and the work plan using the divided areas are stored in the storing unit 112, and the work by the autonomous work machine 130 is started.

### Summary of Embodiments

The above-described embodiments disclose at least an information processing apparatus, an information processing method, and a storage medium in the following.

The above-described information processing apparatus comprises:

a storing unit (for example, 121) configured to store a work plan indicating a work schedule by an autonomous work machine, the work plan using divided areas obtained by virtually dividing a work area;

an identifying unit (for example, 202) configured to identify the divided areas where the work by the autonomous work machine has been completed; and

a notifying unit (for example, 203) configured to give a worker a notification for prompting the worker to conduct work in the divided area where the work by the autonomous work machine has been completed.

According to this embodiment, the divided area where the work of the autonomous work machine 130 has been completed can be identified, and a notification that it is possible to conduct the work in the identified area can be given to the worker. Therefore, during the use of the autonomous work machine, the area where it is possible for the worker to conduct the work can be easily ascertained.

In the above-described information processing apparatus, further comprises

a displaying unit (for example, 124) configured to cause a terminal to display the divided area, wherein

the displaying unit displays in different forms between the divided area where the work by the autonomous work machine has been completed and the divided area where the work by the autonomous work machine has not been completed.

According to this embodiment, the divided area where the work by the autonomous work machine 130 has been completed can be confirmed through the display on the terminal device 120.

In the above-described information processing apparatus, the displaying unit displays in a different form for every type of the work scheduled to be conducted by the worker for the divided area where the work by the autonomous work machine has been completed.

According to this embodiment, it is possible to easily ascertain the work to be conducted by the worker in the divided area with reference to the display on the terminal device 120.

In the above-described information processing apparatus, the displaying unit changes a display to a different form, when the work by the autonomous work machine is completed or when the work by the worker that is recommended is completed for the divided area.

According to this embodiment, the display on the terminal device 120 can be changed in accordance with the progress of the work for every divided area.

In the above-described information processing apparatus, the displaying unit displays in the different forms for a divided area where the autonomous work machine is conducting the work, a divided area adjacent to the divided area where the autonomous work machine is conducting the work, and another divided area, in the work area.

According to this embodiment, it is possible to conduct the work more safely, while avoiding the vicinity of the area where the autonomous work machine is conducting the work.

In the above-described information processing apparatus, the displaying unit displays in different colors, as displaying in the different forms.

According to this embodiment, the areas with different work situations are displayed in different colors, and thus what work should be conducted in the area can be easily understood in a visual manner.

The above-described information processing apparatus further comprises:

an acquiring unit configured to acquire a position of the autonomous work machine in the work area, wherein

when the position of the autonomous work machine moves from a first divided area to a second divided area, the identifying unit identifies the first divided area as the divided area where the work has been completed.

According to this embodiment, when the autonomous work machine moves to the next divided area, the work in the divided area where it was located before the movement can be considered as completion.

In the above-described information processing apparatus, in a case where a working situation by the autonomous work machine in a first divided area, satisfies a predetermined condition, the identifying unit identifies the first divided area as the divided area where the work has been completed.

According to this embodiment, it is possible to determine whether the work has been completed in the divided area in accordance the work situation by the autonomous work machine.

In the above-described information processing apparatus, when a range where the work by the autonomous work machine has been completed in the first divided area is equal to or larger than a predetermined ratio, the identifying unit identifies the first divided area as the divided area where the work has been completed.

According to this embodiment, when the work by the autonomous work machine in the divided area where it is conducting the work sufficiently progresses, it is possible to give a notification for prompting the work by the worker in the divided area.

In the above-described information processing apparatus, when the work by the autonomous work machine in a third divided area is completed, the notifying unit further notifies the worker that the autonomous work machine is going to conduct the work in a fourth divided area where the autonomous work machine is going to conduct the work next.

According to this embodiment, it is possible to clearly notify the worker of the timing when it is possible for the worker to start the work.

In the above-described information processing apparatus, in the work plan, work for hedges is scheduled on a priority basis.

According to this embodiment, the trimmer work of the hedges can be conducted at an early stage.

In the above-described information processing apparatus, in the work plan, work of the autonomous work machine near an obstacle is scheduled on a priority basis.

According to this embodiment, the edger work in the vicinity of the obstacle can be conducted at an early stage.

The above-described information processing apparatus further comprises

a correcting unit configured to correct the work plan, when a delay is occurring in the work by the autonomous work machine with respect to the work plan.

According to this embodiment, even when a delay is occurring in the work conducted in accordance with the work plan, it is possible to flexibly handle with the delay.

An information processing method executed by an information processing apparatus comprising a storing unit (for example, 112) configured to store a work plan indicating a work schedule by an autonomous work machine, the work plan using divided areas obtained by virtually dividing a work area, comprises

identifying (for example, S502) the divided areas where the work by the autonomous work machine has been completed; and

giving (for example, S504) a worker a notification for prompting the worker to conduct work in the divided area where the work by the autonomous work machine has been completed.

According to this embodiment, the divided area where the work of the autonomous work machine 130 has been completed can be identified, and a notification that it is possible to conduct the work in the identified area can be given to the worker. Therefore, during the use of the autonomous work machine, the area where it is possible for the worker to conduct the work can be easily ascertained.

A non-transitory computer-readable storage medium storing a program that, when executed by a computer, causes the computer to perform an information processing method executed by an information processing apparatus comprising a storing unit (for example, 112) configured to store a work plan indicating a work schedule by an autonomous work machine, the work plan using divided areas obtained by virtually dividing a work area, comprises:

identifying (for example, S502) the divided areas where the work by the autonomous work machine has been completed; and

giving (for example, S504) a worker a notification for prompting the worker to conduct work in the divided area where the work by the autonomous work machine has been completed.

According to this embodiment, the divided area where the work of the autonomous work machine 130 has been completed can be identified, and a notification that it is possible to conduct the work in the identified area can be given to the worker. Therefore, during the use of the autonomous work machine, the area where it is possible for the worker to conduct the work can be easily ascertained.

The invention is not limited to the foregoing embodiments, and various variations/changes are possible within the spirit of the invention.

What is claimed is:

1. An information processing apparatus comprising:
a storing unit configured to store a work plan indicating a work schedule by an autonomous work machine, the work plan using divided areas obtained by virtually dividing a work area;
an identifying unit configured to identify the divided areas where the work by the autonomous work machine has been completed; and
a notifying unit configured to give a worker a notification for prompting the worker to conduct work in the divided area where the work by the autonomous work machine has been completed.

2. The information processing apparatus according to claim 1, further comprising
a displaying unit configured to cause a terminal to display the divided area, wherein
the displaying unit displays in different forms between the divided area where the work by the autonomous work machine has been completed and the divided area where the work by the autonomous work machine has not been completed.

3. The information processing apparatus according to claim 2, wherein the displaying unit displays in a different form for every type of the work scheduled to be conducted by the worker for the divided area where the work by the autonomous work machine has been completed.

4. The information processing apparatus according to claim 3, wherein the displaying unit changes a display to a different form, when the work by the autonomous work machine is completed or when the work by the worker that is recommended is completed for the divided area.

5. The information processing apparatus according to claim 2, wherein the displaying unit displays in the different forms for a divided area where the autonomous work machine is conducting the work, a divided area adjacent to the divided area where the autonomous work machine is conducting the work, and another divided area, in the work area.

6. The information processing apparatus according to claim 2, wherein the displaying unit displays in different colors, as displaying in the different forms.

7. The information processing apparatus according to claim 1, further comprising
an acquiring unit configured to acquire a position of the autonomous work machine in the work area, wherein
when the position of the autonomous work machine moves from a first divided area to a second divided area, the identifying unit identifies the first divided area as the divided area where the work has been completed.

8. The information processing apparatus according to claim 1, wherein in a case where a work situation by the autonomous work machine in a first divided area satisfies a predetermined condition, the identifying unit identifies the first divided area as the divided area where the work has been completed.

9. The information processing apparatus according to claim 8, wherein when a range where the work by the autonomous work machine has been completed in the first divided area is equal to or larger than a predetermined ratio, the identifying unit identifies the first divided area as the divided area where the work has been completed.

10. The information processing apparatus according to claim 1, wherein when the work by the autonomous work machine in a third divided area is completed, the notifying unit further notifies the worker that the autonomous work machine is going to conduct the work in a fourth divided area where the autonomous work machine is going to conduct the work next.

11. The information processing apparatus according to claim 1, wherein in the work plan, work for hedges is scheduled on a priority basis.

12. The information processing apparatus according to claim 1, wherein in the work plan, work of the autonomous work near an obstacle machine is scheduled on a priority basis.

13. The information processing apparatus according to claim 1, further comprising
a correcting unit configured to correct the work plan, when a delay is occurring in the work by the autonomous work machine with respect to the work plan.

14. An information processing method executed by an information processing apparatus comprising a storing unit configured to store a work plan indicating a work schedule by an autonomous work machine, the work plan using divided areas obtained by virtually dividing a work area, comprising:
identifying the divided areas where the work by the autonomous work machine has been completed; and
giving a worker a notification for prompting the worker to conduct work in the divided area where the work by the autonomous work machine has been completed.

15. A non-transitory computer-readable storage medium storing a program that, when executed by a computer, causes the computer to perform an information processing method executed by an information processing apparatus comprising a storing unit configured to store a work plan indicating a work schedule by an autonomous work machine, the work plan using divided areas obtained by virtually dividing a work area, comprising:
identifying the divided areas where the work by the autonomous work machine has been completed; and
giving a worker a notification for prompting the worker to conduct work in the divided area where the work by the autonomous work machine has been completed.
